(19) United States
(12) Patent Application Publication
(10) Pub. No.: US 2008/0272003 A1
(43) Pub. Date: Nov. 6, 2008

(54) Method and means for removing phosphorous from waste water or the like

(76) Inventor: Marius Grobler, Payson, AZ (US)

Correspondence Address: THOMTE LAW OFFICE, L.L.C., 2120 S. 72ND STREET, SUITE 1111, OMAHA, NE, 68124, US

(21) Appl. No.: 12/217,989

(22) Filed: Jul. 10, 2008

Related U.S. Application Data
(62) Division of application No. 10/968,617, filed on Oct. 19, 2004.

(51) Int. Cl. C02F 1/469

(52) U.S. Cl. 204/669; 204/668

(57) ABSTRACT

A method and means of removing at least some of the phosphorous contained in waste water wherein waste water is continuously moved through a water treatment chamber wherein positive and negative electrodes are partially immersed in the waste water and are periodically moved through the water so that phosphorous will collect on the positive electrodes to enable the same to be removed from the waste water. Hydrogen and nitrogen are also released by the electrolysis action of this invention.

### CROSS REFERENCE TO RELATED APPLICATION

This is a divisional application of Petitioner's earlier application Ser. No. 10/968,617, filed Oct. 19, 2004, entitled METHOD AND MEANS FOR REMOVING PHOSPHOROUS FROM WASTE WATER OR THE LIKE.

### BACKGROUND OF THE INVENTION

1. Field of the Invention

This invention relates to a method and means for removing phosphorous from waste water or the like and more particularly to a method and means for removing phosphorous from waste water or the like and collecting the same. Still more particularly, the invention relates to a method and means for removing phosphorous, nitrogen and hydrogen from waste water or the like. Even more particularly, the invention relates to a method and means for removing colloidal solids from waste water or the like.

2. Description of the Related Art

The hog and dairy industries have long suffered with the problems of high phosphate levels in the barn flush water and waste water loads. The problem also applies in a lesser degree to municipal waste water systems. Hog and dairy influents may have phosphates in the 4,000 to 7,000 mg/L range while the phosphate in normal municipal influents levels may run in the 10 to 35 mg/L range. The ammonia and nitrogen levels in the animal units are also extremely higher than in a municipal waste water system.

The prior art methods of removing phosphorous from waste water or the like are either biological, requiring large digester ponds, aerobic and anaerobic ponds, or chemical, requiring the addition of chemicals that render the phosphorous insoluble, so that it can be mechanically removed from the waste water.

### SUMMARY OF THE INVENTION

A method and means is provided for removing at least some of the phosphorous contained in waste water or the like which comprises the steps of:

(a) introducing the water to be treated into an elongated water treatment chamber having a water inlet end and a water outlet end;

(b) passing the water to be treated through the chamber at a predetermined rate;

(c) introducing at least one set of electrodes into the water to be treated so that the electrodes are at least partially immersed in the water to be treated;

(d) applying power to the electrodes whereby at least some of the phosphorous in the water collects on at least one of the electrodes;

(e) periodically removing at least the electrode from the water being treated upon which the phosphorous has collected;

(f) removing the phosphorous from the electrode;

(g) periodically re-introducing the electrode into the water being treated after the phosphorous has been removed therefrom; and

(h) repeating the steps of (d) through (g).

The method also causes hydrogen and nitrogen to be released from the water so that it may also be collected. The method of this invention also tends to clarify the water being treated since impurities in the water coagulate and settle to the bottom without the need of adding polymers or the like to cause the coagulation. Another benefit of the method of this invention is that the electrical current in the water is believed to destroy bacteria therein.

It is therefore a principal object of the invention to provide an improved method of removing at least some of the phosphorous contained in waste water or the like and to collect the same to enable the phosphorous to be utilized in other treatment systems.

Still another object of the invention is to provide a method and means for not only removing at least some of the phosphorous contained in the water but which also removes at least some of the nitrogen and at least some of the hydrogen contained in the water being treated.

Still another object of the invention is to provide a method and means for clarifying waste water or the like.

Still another object of the invention is to provide a method and means of removing at least some of the phosphorous, nitrogen and hydrogen contained in waste water or the like which also is believed to destroy at least some of the bacteria contained in the water.

Yet another object of the invention is to provide a method and means which reduces or completely removes phosphorous from waste water or the like.

Yet another object of the invention is to provide a method and means for removing at least some of the phosphorous contained in waste water or the like without the need of using biological or chemical methods.

These and other objects will be apparent to those skilled in the art.

### BRIEF DESCRIPTION OF THE DRAWINGS

FIG. 1 is a perspective view of the apparatus of this invention;

FIG. 2 is a top view of the apparatus of this invention;

FIG. 3 is a side view of the apparatus of this invention;

FIG. 4 is an intake end elevational view of the apparatus of this invention;

FIG. 5 is a discharge end elevational view of the apparatus of this invention;

FIG. 6 is an end view similar to FIG. 4 wherein one of the rotating members is a negative electrode; and

FIG. 7 is a perspective view of a modified form of the apparatus.

### DETAILED DESCRIPTION OF THE INVENTION

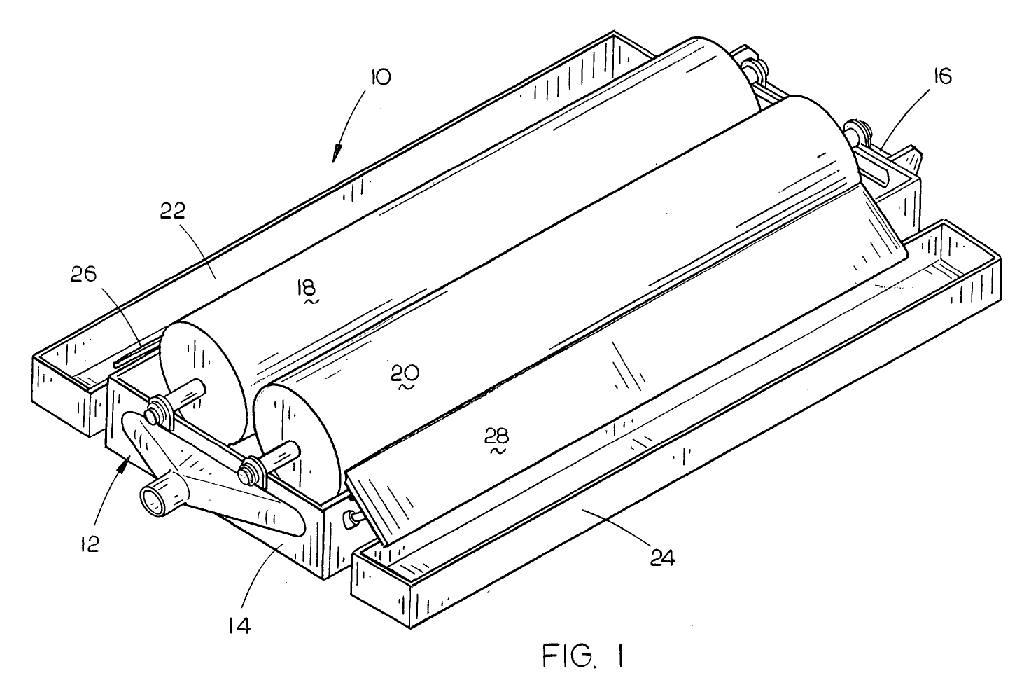

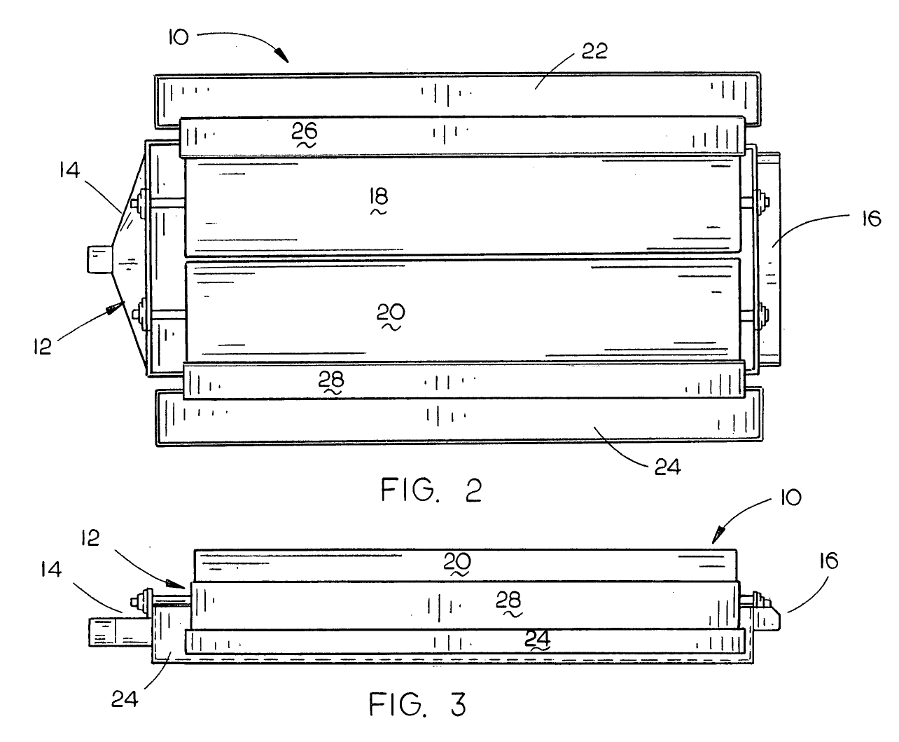

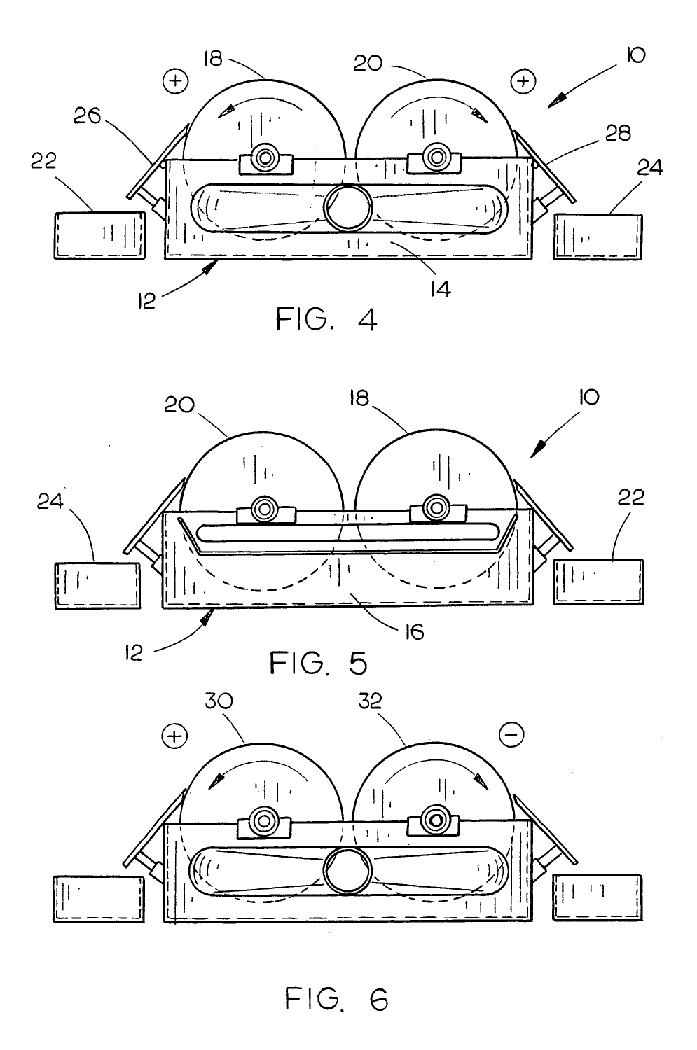

FIGS. 1 through 5 illustrate one form of the apparatus for removing at least some of the phosphorous, nitrogen and hydrogen contained in waste water or the like. The apparatus 10 includes an elongated water treatment chamber 12 having a water inlet end 14 and a water discharge weir or end 16. The chamber 12 has an open upper end, as seen in the drawings. The water inlet end 14 is fluidly connected to the water being treated with the same being supplied to the chamber 12 at a predetermined rate. The water treatment chamber 12 has a sufficient width to slow down the linear flow velocity of the waste water to approximately one foot per minute. A flow rate of fifty gallons per minute requires a channel four feet wide and deep enough to accommodate a flow depth of eighteen inches. The slow flow rate described above prevents deposits on the electrodes, as will be described hereinafter, from being washed therefrom, and extends the treatment retention time, thereby reducing the required applied current.

In the embodiment of FIGS. 1-5, a pair of positively charged electrodes 18 and 20 are provided which are in the form of elongated, horizontally disposed and rotatable cylinders. It is preferred that the cylinders 18 and 20 have a continuous outer surface, but the same could be comprised of a plurality of horizontally spaced-apart disks if so desired as will be described hereinafter. The electrodes 18 and 20 are rotatably driven in opposite directions with respect to one another by an electric gear motor or other conventional means mounted beneath the water discharge end 16. Preferably, the electrodes 18 and 20 are rotated at approximately one R.P.M. to minimize water carryover into the collecting troughs 22 and 24 located on opposite sides of the chamber 12. A pair of wiper assemblies 26 and 28 are mounted on opposite sides of the chamber 12 and are in engagement with the exterior surfaces of the electrodes 18 and 20 to mechanically wipe phosphorous, or other materials collected thereon, from the electrodes 18 and 20 with the material falling into the collecting troughs or receptacles 22 and 24, respectively. In the embodiment of FIGS. 1-5, the chamber 12 is negatively charged and functions as a negatively charged electrode. Preferably, the electrodes are charged with a low direct current voltage which is less than fifty volts.

As seen in FIGS. 1-5, the electrodes 18 and 20 are mounted in the chamber 12 so that they are partially submerged in the water stream. When a direct current is applied to the electrodes, electrolysis occurs and phosphorous is deposited on the submerged portion of the positively charged electrodes 18 and 20. At the same time, hydrogen gas and nitrogen gas is liberated at one or more of the electrodes. The hydrogen and nitrogen gas may be collected by any conventional means. The phosphorous collected in the troughs 22 and 24 may removed therefrom by a screw conveyor or filter belt conveyor.

It is also believed that the electrolysis action within the chamber 12 destroys bacteria in the water to improve the quality of the water. Additionally, the electrolysis within the chamber 12 causes colloidal materials in the waste water to coagulate and settle to the bottom of the chamber 12 which markedly improves the clarity of the water. The colloidal solids may be removed from the chamber 12 by any convenient means.

A modified form the invention is illustrated in FIG. 6 wherein a rotatable positively charged electrode 30 is positioned adjacent a negatively charged electrode 32. In the embodiment of FIG. 6, the electrodes 30 and 32 are rotated in the same manner as in the embodiment of FIGS. 1-5. In the embodiment of FIG. 6, phosphorous will collect on the electrode 30 and other positively charged materials contained in the water will collect on the negatively charged electrode 32. Hydrogen and nitrogen will also be released from one or more of the electrodes. Thus, the apparatus of FIG. 6 not only collects phosphorous and other materials in the water but also releases hydrogen and nitrogen gas.

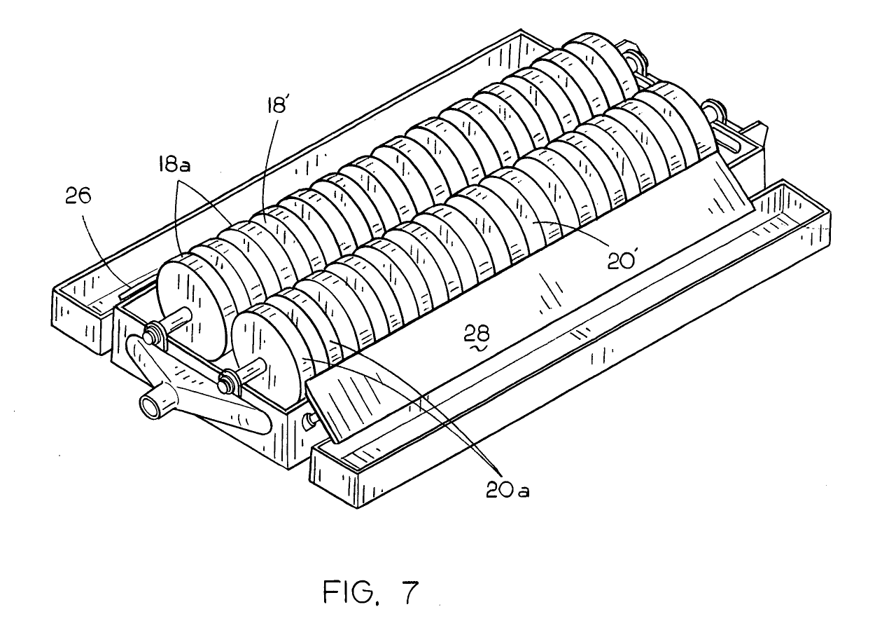

FIG. 7 illustrates a modified form of the invention. The electrodes 18′ and 20′ are comprised of a plurality of spaced-apart discs 18a and 20a, respectively. Although the wiper assemblies 28 and 28 are illustrated as wiping upon the outer surfaces of the discs 18a and 20a, respectively, the wiper assemblies 26 and 28 may also be configured so as to at least partially extend into the spaces between the discs to wipe collected material from the opposite sides of the discs.

Thus it can be seen that a novel method and means has been provided for partially or completely removing phosphorous from waste water or the like. The method and means of this invention operates continuously through the constantly rotating electrodes being in contact with the water continuously flowing through the treatment chamber, the length of which will depend upon the desired retention time of the water therein. Although it is preferred that rotating cylinders or disks be rotated through the water being treated, the positive electrodes and even positive and negative electrodes could be vertically moved downwardly into the water and periodically removed upwardly from the water with the phosphorous and other materials collected on the vertically movable electrodes being mechanically cleaned so that the materials thereon may be collected.

Thus it can be seen that the invention accomplishes at least all of its stated objectives.

1. An apparatus for removing at least some of the phosphorous contained in water, comprising:
a water treatment chamber having a water inlet end and a water outlet end;
said chamber having means associated therewith for passing water through said chamber from its inlet end through said outlet end;
a negatively charged electrode in contact with the water passing through said chamber;
a positively charged electrode in contact with the water passing through said chamber;
a direct current power source electrically connected to said electrodes;
said positively charged electrode being movable from a first position wherein it is at least partially submerged in the water passing through said chamber to a second position wherein the submerged portion of the positively charged electrode is removed from the water to facilitate phosphorous collected on said positively charged electrode to be removed therefrom.

2. The apparatus of claim 1 wherein said negatively charged electrode is also removably submerged in the water passing through said chamber.

3. The apparatus of claim 2 wherein said positively charged electrode comprises a horizontally disposed and rotatable cylinder.

4. The apparatus of claim 1 wherein means is provided for continuously passing water through said chamber.

5. The apparatus of claim 1 wherein said negatively charged electrode comprises the chamber.

6. The apparatus of claim 5 wherein said positively charged electrode comprises a horizontally disposed, rotatable cylinder.
